(19) United States
(12) Patent Application Publication
(10) Pub. No.: US 2021/0222468 A1
(43) Pub. Date: Jul. 22, 2021

(54) SYSTEM AND METHOD FOR CONTROLLING OPENING AND CLOSING OF CHARGING DOOR OF VEHICLE

(71) Applicants: Hyundai Motor Company, Seoul (KR); Kia Motors Corporation, Seoul (KR)

(72) Inventors: Xin Dong, Seoul (KR); Seoktae Son, Seoul (KR)

(21) Appl. No.: 16/984,407

(22) Filed: Aug. 4, 2020

(30) Foreign Application Priority Data
Jan. 22, 2020 (CN) 202010075033.8

(51) Int. Cl. E05B 81/72; B60R 16/00; B60R 25/34; B60R 25/25; B60R 16/023; E05B 83/34; E05B 63/22

(52) U.S. Cl. CPC E05B 81/72; B60R 16/005; B60R 25/34; E05Y 2900/534; B60R 16/0231; E05B 83/34; E05B 63/22; B60R 25/252

(57) ABSTRACT

A system and a method for controlling opening and closing of a charging door of a vehicle are provided. The system includes a switch sensor that is mounted at the charging door to receive a pressing signal when the charging door switch of the vehicle is pressed. A controller determines whether a door lock of the vehicle is in a locked state to operate the charging door switch of the vehicle. When the door lock of the vehicle is in an unlocked state and the charging door switch of the vehicle is continuously pressed for more than a predetermined time, the controller processes the received pressing signal to determine whether the received pressing signal received is caused by a user manipulation. The charging door is opened when the pressing signal is caused by the user manipulation.

### CROSS-REFERENCE TO RELATED APPLICATION

This application claims priority to and the benefit of Chinese Patent Application No. 202010075033.8 filed on Jan. 22, 2020, the entire contents of which are incorporated herein by reference.

### BACKGROUND

### (a) Field of the Disclosure

The disclosure relates to a system and a method for controlling opening and closing of a charging door of a vehicle.

### (b) Description of the Related Art

With the popularization of new energy vehicles such as electric vehicles (EVs) and hybrid electric vehicles (HEVs), use of charging door switches for these vehicles has become more frequent. At present, most of the charging door switches of vehicles have mechanical structures. When a particular force is applied to the charging door switch of the mechanical structure, the charging door switch will open. However, the charging door switch in the related art is unable to detect whether the applied force is caused by human operation. When the applied force is not caused by the human operation, for example during a car wash, etc., high-pressure water sprayed from a high-pressure nozzle may press against the charging door switch causing the charging door to open. Therefore, when water infiltrates into the charging door of the vehicle, there is a risk of short circuit. Therefore, there is a need for a system and a method capable of preventing the charging door from being opened due to malfunction or non-human operation.

The above information disclosed in this section is merely for enhancement of understanding of the background of the disclosure, and therefore it may contain information that does not form the prior art that is already known in this country to a person of ordinary skill in the art.

### SUMMARY

The present disclosure provides a system and a method for controlling opening and closing of a charging door of a vehicle having advantages of recognizing whether a pressing pressure applied to the charging door is caused by human operation and preventing the charging door from being opened due to non-human operation or malfunction by further operating a charging door switch to remain closed or open. In particular, during a car wash or the like, it is possible to prevent the charging door from being opened due to a pressure of high-pressure water sprayed by a high-pressure nozzle, thereby ensuring that no short circuit due to water infiltration occurs, and further improving safety and overall stability of the vehicle.

An exemplary embodiment of the present disclosure may provide a system for controlling opening and closing of a charging door of a vehicle. The system may include a switch sensor and a controller. The switching sensor may be mounted at the charging door of the vehicle to receive a pressing signal when the charging door switch is pressed, and the controller may be configured to determine whether a door lock of the vehicle is in a locked state to operate the charging door switch of the vehicle. In response to determining that the door lock of the vehicle is not in the locked state and the charging door switch is continuously pressed for more than a predetermined time, the controller may be configured to process the pressing signal received by the switch sensor to determine whether the pressing signal received by the switch sensor is caused by a user engagement. In response to determining that the pressing signal received by the switch sensor is caused by the user engagement, the controller may be configured to open the charging door switch of the vehicle.

In an exemplary embodiment of the present disclosure, the switch sensor may be configured to receive various signals related to the pressing when the charging door switch is pressed. For example, the pressing signal may include, but not limited to, a pressing acceleration signal, a pressing time signal, a multi-points (multi-regions) pressing signal, etc. The controller may be configured to: process the pressing signal received by the switch sensor to obtain a voltage-time relationship curve, perform a fast Fourier transform on the obtained voltage-time relationship curve to obtain a voltage-frequency relationship curve, and process the obtained voltage-frequency relationship curve to determine whether a voltage exceeding a predetermined voltage value exists within a predetermined frequency range.

In addition, the controller may be configured to determine that the pressing signal received by the switch sensor is caused by the user pressing or engagement in response to determining that the voltage exceeding the predetermined voltage value does not exist within the predetermined frequency range. In this exemplary embodiment, the switch sensor may include an acceleration sensor, and the controller may be configured to process the pressing acceleration signal in the received pressing signal to obtain the voltage-time relationship curve, and then perform a fast Fourier transform to obtain the voltage-frequency relationship curve. After that, the controller may be configured to process the obtained voltage-frequency relationship curve to determine whether the voltage exceeding the predetermined voltage value exists within the predetermined frequency range.

In some exemplary embodiments, the predetermined frequency range may be about 10 Hz or more, and preferably, the predetermined frequency range may be 10 Hz to 100 Hz. In some exemplary embodiments, the predetermined voltage value may be about 0.01V. The predetermined voltage value may be determined by an acceleration sensor included in the switch sensor. When using different types of acceleration sensors, the predetermined voltage values may be different from each other. In some exemplary embodiments, in response to determining that the voltage exceeding the predetermined voltage value exists within the predetermined frequency range, the controller may be configured to maintain the charging door switch of the vehicle in a closed state.

The controller may be configured to process the pressing signal received by the switch sensor and determine that the pressing signal received by the switch sensor is caused by the user pressing in response to determining that two or more areas on the charging door which are distanced from each other by a predetermined distance are simultaneously pressed or engaged.

In some exemplary embodiments, the predetermined distance may be 3 cm or greater, and preferably, the predetermined distance may be 3 cm to 10 cm. To more accurately identify the user engagement of the switch, a predetermined distance between the areas pressed by fingers may be obtained through multiple experiments. The predetermined distance conforms to a habit of the human pressing. Additionally, it may be effectively determined that the pressing the two or more areas simultaneously is caused not by a foreign object or malfunction, but by the pressing by the user's finger. The two or more areas may be two or more positions on the charging door, or two or more physical buttons or touch buttons on the charging door.

In some exemplary embodiments, the switch sensor may further include a fingerprint recognition module, and the controller may be configured to process the pressing signal received by the switch sensor to determine whether a fingerprint identified in the received pressing signal coincides with a pre-registered fingerprint, and determine that the pressing signal received by the switch sensor is caused by the user pressing when the fingerprint identified in the received pressing signal coincides with the pre-registered fingerprint.

In response to determining that the door lock of the vehicle is in the locked state, the controller may be configured to maintain the charging door switch in the closed state. In some exemplary embodiments, when the charging door switch of the vehicle is not continuously pressed for more than the predetermined time, the controller may be configured to maintain the charging door switch of the vehicle in the closed state. In some exemplary embodiments, the predetermined time may be about 0.05 sec to 0.2 sec.

Exemplary embodiments of the present disclosure may provide a method for controlling opening and closing of a charging door of a vehicle. The method may include receiving, by a switch sensor, a pressing signal when a charging door switch of the vehicle is pressed; determining, by a controller, whether a door lock of the vehicle is in a locked state; processing, by the controller, the pressing signal received by the switch sensor to determine whether the pressing signal received by the switch sensor is caused by a user pressing when the door lock of the vehicle is not in the locked state and the charging door switch of the vehicle is continuously pressed for more than a predetermined time; opening, by the controller, the charging door switch of the vehicle in response to determining that the pressing signal received by the switch sensor is caused by the user pressing.

The controller may be configured to process the pressing signal received by the switch sensor to obtain a voltage-time relationship curve; perform a fast Fourier transform on the obtained voltage-time relationship curve to obtain a voltage-frequency relationship curve, and process the obtained voltage-frequency relationship curve to determine whether a voltage exceeding a predetermined voltage value exists within a predetermined frequency range.

In addition, the controller may be configured to determine that the pressing signal received by the switch sensor is caused by the user pressing in response to determining that the voltage exceeding the predetermined voltage value does not exist within the predetermined frequency range. In this exemplary embodiment, the controller may be configured to process a pressing acceleration signal in the received pressing signal to obtain the voltage-time relationship curve, and then perform a fast Fourier transform to obtain the voltage-frequency relationship curve. After that, the controller may be configured to process the obtained voltage-frequency relationship curve to determine whether the voltage exceeding the predetermined voltage value exists within the predetermined frequency range.

In some exemplary embodiments, the predetermined frequency range may be about 10 Hz or more, and preferably, the predetermined frequency range may be about 10 Hz to 100 Hz. In some exemplary embodiments, the predetermined voltage value may be about 0.01V. The predetermined voltage value may be determined by an acceleration sensor included in the switch sensor. When using different types of acceleration sensors, the predetermined voltage values may be different from each other.

In some exemplary embodiments, in response to determining that the voltage exceeding the predetermined voltage value exists within the predetermined frequency range, the controller may be configured to maintain the charging door switch of the vehicle in a closed state. The controller may be configured to process the pressing signal received by the switch sensor; and determine that the pressing signal received by the switch sensor is caused by the user pressing in response to determining that two or more areas on the charging door which are distanced from each other by a predetermined distance are simultaneously pressed.

In some exemplary embodiments, the predetermined distance may be about 3 cm or greater, and preferably, the predetermined distance may be about 3 cm to 10 cm. The switch sensor may further include a fingerprint recognition module, and the controller may be configured to process the pressing signal received by the switch sensor to determine whether a fingerprint identified in the received pressing signal coincides with a pre-registered fingerprint, and determine that the pressing signal received by the switch sensor is caused by the user pressing when the fingerprint identified in the received pressing signal coincides with the pre-registered fingerprint.

In response to determining that the door lock of the vehicle is in the locked state, the controller may be configured to maintain the charging door switch of the vehicle in the closed state. In some exemplary embodiments, when the charging door switch of the vehicle is not continuously pressed for more than the predetermined time, the controller may be configured to maintain the charging door switch of the vehicle in the closed state. In some exemplary embodiments, the predetermined time may be about 0.05 sec to 0.2 sec.

According to an exemplary embodiment of the present disclosure, during car washing or the like, it may be possible to prevent the charging door from being opened due to a pressure of high-pressure water sprayed by a high-pressure nozzle, thereby ensuring that no short circuit due to water infiltration occurs, and further improving safety and overall stability of the vehicle.

The effects of the present disclosure are not limited to the above description, and the effects obtainable or expected by applying the exemplary embodiments of the present disclosure, in addition to the above-mentioned beneficial effects, will also be explicitly or implicitly disclosed in the detailed description of the embodiments of the present disclosure. In other words, various effects that can be expected by applying the exemplary embodiments of the present disclosure will be disclosed in the following detailed description.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present invention, and wherein:

FIG. 1 shows a block diagram of a system for controlling opening and closing of a charging door of a vehicle according to an exemplary embodiment of the present disclosure.

FIG. 2 shows a flowchart of a method for controlling opening and closing of a charging door of a vehicle according to an exemplary embodiment of the present disclosure.

FIG. 3 shows a flowchart of a method for controlling opening and closing of a charging door of a vehicle according to an exemplary embodiment of the present disclosure.

FIGS. 4A and 4B are graphs of a voltage-time relationship curve obtained after processing a pressing signal received by a switch sensor according to an exemplary embodiment of the present disclosure.

FIGS. 5A and 5B are graphs of a voltage-frequency relationship curve obtained by performing a fast Fourier transform on an obtained voltage-time relationship curve according to an exemplary embodiment of the present disclosure.

### DETAILED DESCRIPTION

The above and other objects, features and advantages of the present disclosure will be more clearly understood through the exemplary embodiments presented below in conjunction with the accompanying drawings. However, the present disclosure is not limited to the exemplary embodiments disclosed herein, but can be modified into different forms. These exemplary embodiments are provided to thoroughly explain the present disclosure and fully convey the spirit of the present disclosure to those skilled in the art.

It should be understood that the terms “comprising”, “including”, “having”, etc., when used in this specification, specify the presence of stated features, integers, steps, operations, elements, and/or components, but do not preclude the presence or addition of one or more other features, integers, steps, operations, elements, components, and/or groups thereof. In addition, that a part such as a layer, a film, a region, or a sheet is “on” another part includes that the part is directly on another part as well as that other part is disposed between the part and another part. On the other hand, that a part such as a layer, a film, a region, or a sheet is “under” another part includes that the part is directly under another part as well as that other part is disposed between the part and another part.

Unless otherwise stated, all numbers, values, and/or expressions used herein to denote components, reaction conditions, amounts of polymer compositions, and mixtures should be deemed to include various uncertainties (when obtaining these values, the uncertainties can affect measured values), and therefore should be understood as modified by the term “about” in all cases. In addition, unless otherwise stated, when a numerical range is disclosed in this specification, the range is continuous and includes all values from the minimum value to the maximum value of the range. In addition, unless otherwise stated, when such a range involves integer values, all integers from the minimum value to the maximum value of the range are included.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

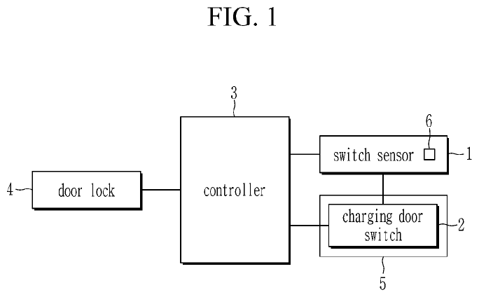

The following is a detailed description of the disclosure. FIG. 1 shows a block diagram of a system for controlling opening and closing of a charging door of a vehicle according to an exemplary embodiment of the present disclosure. In the exemplary embodiment of the present disclosure shown in FIG. 1, the system for controlling opening and closing of the charging door of the vehicle may include a switch sensor 1 and a controller 3.

In particular, the switch sensor 1 may be a conventional sensor in the art. The switch sensor 1 may be mounted at the charging door 5 of the vehicle to receive a pressing signal when a charging door switch 2 of the vehicle is pressed or engaged. The switch sensor 1 may be configured to receive various signals related to the pressing or force applied to the switch when the charging door switch is pressed, for example, the pressing signal may include, but not limited to, a pressing acceleration signal, a pressing time signal, a multi-points (multi-regions) pressing signal, a pressing fingerprint information signal, etc.

The controller 3 may be an electronic control unit (ECU) for the vehicle. The controller 3 may be configured to receive and output various signals via a controller area network (CAN) to operate the charging door of the vehicle.

The controller 3 may be configured to determine whether a door lock 4 of the vehicle is in a locked state and to operate the charging door switch 2 of the vehicle. The controller 3 may be configured to process the pressing signal received by the switch sensor 1 to determine whether the pressing signal received by the switch sensor 1 is caused by a user pressing (e.g., user engagement) when the door lock 4 of the vehicle is not in the locked state and the charging door switch 2 is continuously pressed for more than a predetermined time. In response to determining that the pressing signal received by the switch sensor 1 is caused by the user pressing (e.g., force exerted onto the switch by a user), the controller 3 may be configured to open the charging door switch 2 of the vehicle.

The processes where the controller 3 processes the pressing signal received by the switch sensor 1 to determine whether the pressing signal received by the switch sensor 1 is caused by the user pressing may be implemented in various exemplary embodiments. In some exemplary embodiments, the controller 3 may be configured to process the pressing signal received by the switch sensor, and to determine that the pressing signal received by the switch sensor is caused by the user pressing in response to determining that two or more areas on the charging door that are distanced from each other by a predetermined distance are pressed simultaneously.

The predetermined distance may be about 3 cm or greater, and preferably, the predetermined distance may be about 3 cm to 10 cm. To more accurately identify the user engagement of the switch, a preferable predetermined distance between the areas pressed by fingers may be obtained through multiple experiments. The preferred predetermined distance may be more conducive to determining that the two or more areas are pressed simultaneously by the user's finger, not by collision by a foreign object or malfunction. The two or more areas may be two or more positions on the charging door, or two or more physical buttons or touch buttons on the charging door. In this exemplary embodiment, identification by three-fingers pressing is used, and the predetermined distance may be about 5 cm.

In some exemplary embodiments, the switch sensor 1 may further include a fingerprint recognition module 6, and the controller 3 may be configured to process the pressing signal received by the switch sensor 1 to determine whether a fingerprint identified in the received pressing signal coincides with a pre-registered fingerprint, and determine that the pressing signal received by the switch sensor 1 is caused by the user pressing when the fingerprint identified in the received pressing signal coincides with the pre-registered fingerprint.

In addition, the controller 3 may be configured to: process the pressing signal received by the switch sensor 1 to obtain a voltage-time relationship curve; perform a fast Fourier transform on the obtained voltage-time relationship curve to obtain a voltage-frequency relationship curve; process the obtained voltage-frequency relationship curve to determine whether a voltage exceeding a predetermined voltage value is within a predetermined frequency range; determine that the pressing signal received by the switch sensor 1 is caused by the user pressing in response to determining that the voltage exceeding the predetermined voltage value is not within the predetermined frequency range. In this exemplary embodiment, the switch sensor 1 may include an acceleration sensor, and the controller may be configured to process the pressing acceleration signal in the received pressing signal to obtain the voltage-time relationship curve, and then perform a fast Fourier transform to obtain the voltage-frequency relationship curve, and then processes the obtained voltage-frequency relationship curve to determine whether the voltage exceeding the predetermined voltage value is within the predetermined frequency range.

The predetermined frequency range may be about 10 Hz or more, and preferably, the predetermined frequency range may be about 10 Hz to 100 Hz. The predetermined voltage value may be about 0.01V. The predetermined voltage value may generally depend on an acceleration sensor used. In other words, since different types of acceleration sensors are used, the predetermined voltage values may be different from each other. The controller 3 may be configured to maintain the charging door switch 2 of the vehicle in a closed state in response to determining that the voltage exceeding the predetermined voltage value is within the predetermined frequency range.

According to the exemplary embodiments, it may be accurately determined whether the pressing signal is caused by the user pressing under various conditions. The exemplary embodiments not only conforms to the user's pressing habits, but also more accurately determines the user pressing when the user wears gloves in case of poor weather conditions such as winter. Therefore, opening of the charging door due to non-human operations or malfunctions may be effectively prevented under various usage environments.

The controller 3 may be configured to maintain the charging door switch 2 of the vehicle in the closed state in response to determining that the door lock 4 of the vehicle is in the locked state. To ensure safety of the vehicle, when the door lock 4 of the vehicle is in the locked state (e.g., when the vehicle is locked), the charging door switch is unable to be opened by manually pressing the charging door.

The controller 3 may be configured to maintain the charging door switch 2 of the vehicle in the closed state when the charging door switch 2 of the vehicle is not continuously pressed for more than the predetermined time. When the charging door of the vehicle momentarily butts (e.g., the vehicle collides with other foreign objects such as small stones) and is momentarily pressed, that is, when it is not continuously pressed for more than the predetermined time, the controller may be configured to determine that the pressing is not caused by human and thus, maintain the charging door switch 2 in the closed state. The predetermined time may be time duration of manual pressing, may be about 0.05 sec or greater, and preferably be about 0.05 sec to 0.2 sec. The time duration of manual pressing in this embodiment may be about 0.1 sec.

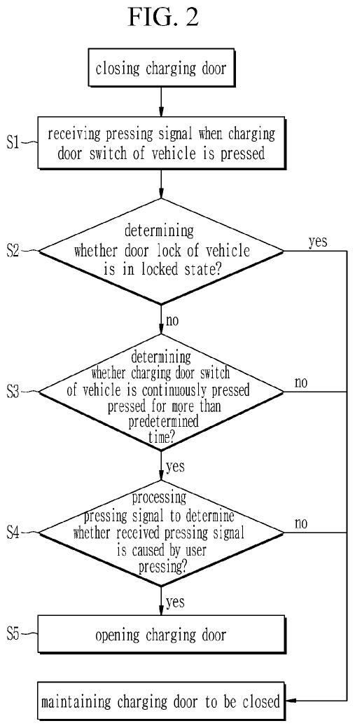

FIG. 2 shows a flowchart of a method for controlling opening and closing of a charging door of a vehicle according to an exemplary embodiment of the present disclosure. The method described herein below may be executed by the controller. In the exemplary embodiment shown in FIG. 2, the method for controlling opening and closing of a charging door of a vehicle may include: at step S1, receiving the pressing signal when the charging door switch of the vehicle is pressed through the switch sensor and at step S2, determining by the controller whether the door lock of the vehicle is in the locked state; The method may further include when the door lock of the vehicle is not in the locked state, determining whether the charging door switch of the vehicle is continuously pressed for more than the predetermined time at step S3; in response to determining that the charging door switch of the vehicle is continuously pressed for more than the predetermined time, processing, by the controller, the pressing signal received by the switch sensor to determine whether the pressing signal received by the switch sensor is caused by the user pressing at step S4; and in response to determining that the pressing signal received by the switch sensor is caused by the user pressing (e.g., user engagement), opening, by the controller, the charging door switch of the vehicle at step S5.

At the step S4, the processing, by the controller, of the pressing signal received by the switch sensor to determine whether the pressing signal received by the switch sensor is caused by the user pressing may be implemented in various exemplary embodiments. In some exemplary embodiments, the controller may be configured to process the pressing signal received by the switch sensor, and determine that the pressing signal received by the switch sensor is caused by the user pressing in response to determining that two or more areas on the charging door that are distanced from each other by the predetermined distance are pressed simultaneously.

The predetermined distance may be about 3 cm or greater, and preferably, the predetermined distance may be about 3 cm to 10 cm. To more accurately identify the user pressing, a preferable predetermined distance between the areas pressed by fingers may be obtained through multiple experiments. The preferable predetermined distance is preferably used to determine that the pressing the two or more areas simultaneously is caused not by a foreign object or malfunction, but by the pressing by the user's finger. The two or more areas may be two or more positions on the charging door, or two or more physical buttons or touch buttons on the charging door. In this exemplary embodiment, three-fingers-pressing-identification is used, and the predetermined distance may be about 5 cm.

In some exemplary embodiments, the switch sensor may include the fingerprint recognition module 6, and the controller may be configured to process the pressing signal received by the switch sensor 1 to determine whether the fingerprint identified in the received pressing signal coincides with the pre-registered fingerprint. When the fingerprint identified in the received pressing signal coincides with the pre-registered fingerprint, the controller may be configured to determine that the pressing signal received by the switch sensor is caused by the user pressing or engagement.

The method may further include, at the step S2, in response to determining that the door lock of the vehicle is in the locked state, maintaining, by the controller, the charging door switch of the vehicle in the closed state. To ensure the safety of the vehicle, when the door lock of the vehicle is in the locked state (e.g., when the vehicle is locked), the charging door switch is unable be opened by manually pressing the charging door.

The method may further include, at the step S3, in response to determining that the charging door switch of the vehicle is not continuously pressed for more than the predetermined time, maintaining, by the controller, the charging door switch of the vehicle in the closed state. When the charging door of the vehicle momentarily butts (e.g., the vehicle collides with other foreign objects such as small stones) and is momentarily pressed, that is, when it is not continuously pressed for more than the predetermined time, the controller may be configured to determine that the pressing is not caused by human and thus maintain the charging door switch 2 in the closed state. The predetermined time may be time duration of the manual pressing, may be about 0.05 sec or more, and preferably be about 0.05 sec to 0.2 sec. The time duration of manual pressing in this exemplary embodiment may be about 0.1 sec. The method may further include, at the step S5, in response to determining that the pressing signal received by the switch sensor is not caused by the user pressing, maintaining, by the controller, the charging door switch of the vehicle in the closed state.

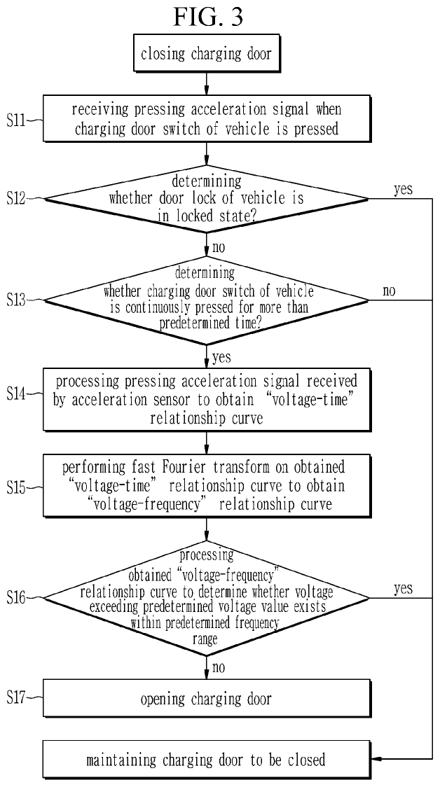

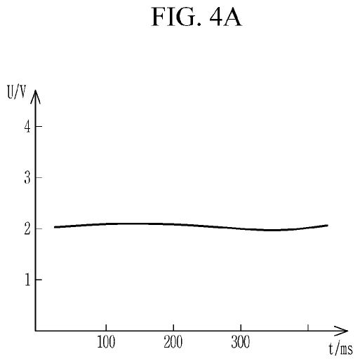

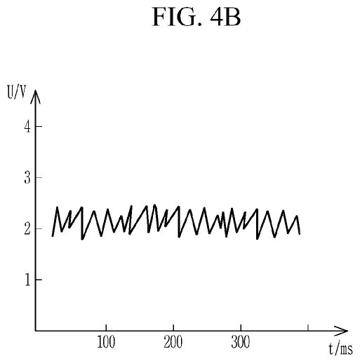

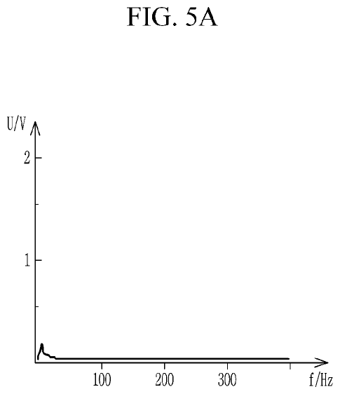

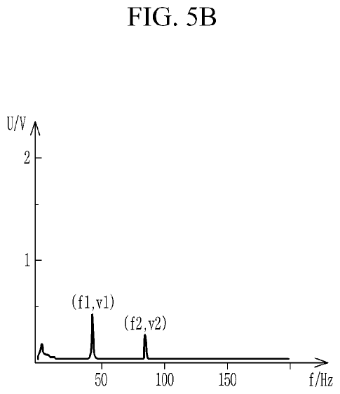

Referring to FIG. 3, FIG. 4A, FIG. 4B, FIG. 5A and FIG. 5B, the exemplary embodiments of the present disclosure will hereinafter be described in detail. FIG. 3 shows a flowchart of a method for controlling opening and closing of a charging door of a vehicle according to an exemplary embodiment of the present disclosure. In the embodiment shown in FIG. 3, a method for controlling opening and closing of a charging door of a vehicle may include: at step S11, receiving, by the switch sensor, the pressing signal when the charging door switch of the vehicle is pressed; at step S12, and determining, by the controller, whether the door lock of the vehicle is in the locked state.

In response to determining that the door lock of the vehicle is not in the locked state, the method may include determining whether the charging door switch of the vehicle is continuously pressed for more than the predetermined time at step S13; and in response to determining that the charging door switch of the vehicle is continuously pressed for more than the predetermined time, processing, by the controller, the pressing signal received by the switch sensor, to obtain the voltage-time relationship curve at step S14.

At step S15, the method may include performing, by the controller, the fast Fourier transform on the obtained voltage-time relationship curve to obtain the voltage-frequency relationship curve; at step S16, processing, by the controller, the obtained voltage-frequency relationship curve to determine whether the voltage exceeding the predetermined voltage value is within the predetermined frequency range; and in response to determining that the voltage exceeding the predetermined voltage value is not within the predetermined frequency range, opening, by the controller, the charging door switch of the vehicle at step S17.

In this exemplary embodiment, the switch sensor may include the acceleration sensor. The controller may be configured to process the pressing acceleration signal in the received pressing signal to obtain the voltage-time relationship curve, and then performs the fast Fourier transform to obtain the voltage-frequency relationship curve, and then process the obtained voltage-frequency relationship curve to determine whether the voltage exceeding the predetermined voltage value is within the predetermined frequency range.

The method may further include, at the step S12, in response to determining that the door lock of the vehicle is in the locked state, maintaining, by the controller, the charging door switch of the vehicle in the closed state. To ensure the safety of the vehicle, when the door lock of the vehicle is in the locked state (e.g., when the vehicle is locked), the charging door switch is unable be opened by manually pressing the charging door.

The method may further include, at the step S13, in response to determining that the charging door switch of the vehicle is not continuously pressed for more than the predetermined time, maintaining, by the controller, the charging door switch of the vehicle in the closed state. When the charging door of the vehicle momentarily butts (e.g., the vehicle collides with other foreign objects such as small stones) and is momentarily pressed, that is, when it is not continuously pressed for more than the predetermined time, the controller may be configured to determine that the pressing is not caused by human and maintain the charging door switch 2 in the closed state. The predetermined time may be time duration of manual pressing, may be about 0.05 sec or more, and preferably be about 0.05 sec to 0.2 sec. The time duration of manual pressing in this exemplary embodiment may be about 0.1 sec.

The method may further include, at the step S16, in response to determining that the voltage exceeding the predetermined voltage value is within the predetermined frequency range, maintaining, by the controller, the charging door switch of the vehicle in the closed state. The predetermined frequency range may be about 10 Hz or more, and preferably about 10 Hz to 100 Hz. The predetermined voltage value may be about 0.01V. The predetermined voltage value may generally depend on an acceleration sensor used. That is, as different types of acceleration sensors may be used, the predetermined voltage values may be different from each other.

According to the exemplary embodiment, whether the pressing signal is caused by the user pressing may be accurately determined under various conditions. The exemplary embodiments not only conform to the user's pressing habits, but also more accurately determine the user pressing when the user wears gloves in case of poor weather conditions such as winter. Therefore, opening of the charging door due to non-human operations or malfunctions may be effectively prevented under various usage environments.

Referring to FIG. 4A, FIG. 4B, FIG. 5A, and FIG. 5B, the exemplary embodiments of the present disclosure will be exemplarily described. FIG. 4A is an exemplary embodiment of the present disclosure, and is a schematic diagram of the voltage-time relationship curve obtained by processing, the controller, the pressing signal (e.g., the pressing acceleration signal) received by the switch sensor (which is mounted at the charging door) when a person manually presses or applies force to the charging door.

FIG. 4B is an exemplary embodiment of the present disclosure, and is a schematic diagram of the voltage-time relationship curve obtained by processing, the controller, the pressing signal (e.g., the pressing acceleration signal) received by the switch sensor (which is mounted at the charging door) when high-pressure water is sprayed to the charging door using a high-pressure nozzle. FIG. 5A is an exemplary embodiment of the present disclosure, and is a schematic diagram of the voltage-frequency relationship curve obtained by performing the fast Fourier transform on the voltage-time relationship curve obtained by the controller when a person manually presses the charging door.

FIG. 5B is an exemplary embodiment of the present disclosure, and is a schematic diagram of the voltage-frequency relationship curve obtained by performing the fast Fourier transform on the voltage-time relationship curve obtained by the controller when high-pressure water is sprayed to the charging door by using the high-pressure nozzle. In FIG. 5B, (f1, v1) is (40 Hz, 0.4 V), and (f2, v2) is (80 Hz, 0.2 V).

The switch sensor 1 in this exemplary embodiment may include a conventional SCA10000-N1000070 acceleration sensor. The voltage-time relationship curves shown in FIGS. 4A and 4B are obtained when the charging door is manually pressed and when the high-pressure water is sprayed to the charging door using the high-pressure nozzle, respectively. The voltage-time relationship curves shown in FIGS. 5A and 5B are obtained by preforming, by the controller, the fast Fourier transform on the obtained voltage-frequency relationship curves.

When the charging door is manually pressed, as shown in FIG. 5A, the voltage value in a region where a frequency exceeds 10 Hz approaches 0V and does not exceed 0.01V. At this time, since the controller may be configured to determine that the pressing is caused normally by a user manipulation, the controller may be configured to operate the charging door switch to open the charging door. When the high-pressure water is sprayed at the charging door using the high-pressure nozzle, as shown in FIG. 5B, since the voltage value exceeding 0.01 V appears in the region where the frequency exceeds 10 Hz, the controller may be configured to determine that the pressing is caused by a non-human pressing or an erroneous pressing. The charging door may remain closed to prevent water from seeping into the charging door and causing a short circuit.

The system and the method for controlling opening and closing of the charging door of the vehicle according to exemplary embodiments of the present disclosure may recognize whether the pressing pressure applied to the charging door is caused by human operation and prevent the charging door from being opened due to the non-human operation or the malfunction by further operating the charging door switch to remain closed or open. In particular, in a case of car washing or the like, it may be possible to prevent the charging door from being opened due to a pressure of high-pressure water sprayed by a high-pressure nozzle, thereby ensuring that no short circuit due to water infiltration occurs, and further improving safety and overall stability of the vehicle.

While this disclosure has been described in connection with what is presently considered to be practical exemplary embodiments, it is to be understood that the disclosure is not limited to the disclosed exemplary embodiments. On the contrary, it is intended to cover various modifications and equivalent arrangements included within the spirit and scope of the appended claims.

What is claimed is:

1. A system for controlling opening and closing of a charging door of a vehicle, comprising:
a switch sensor mounted at the charging door of the vehicle and configured to receive a pressing signal in response to manipulation of a charging door switch of the vehicle; and
a controller configured to determine whether a door lock of the vehicle is in a locked state and operate the charging door switch of the vehicle,
wherein, in response to determining that the door lock of the vehicle is in an unlocked state and the charging door switch of the vehicle is continuously pressed for more than a predetermined time, the controller is configured to process the pressing signal received by the switch sensor to determine whether the pressing signal received by the switch sensor is caused by a user manipulation, and
wherein the controller is operate the charging door switch of the vehicle to open the charging door in response to determining that the pressing signal received by the switch sensor is caused by the user manipulation.

2. The system of claim 1, wherein the controller is configured to:
process the pressing signal received by the switch sensor to obtain a voltage-time relationship curve;
perform a fast Fourier transform on the obtained voltage-time relationship curve to obtain a voltage-frequency relationship curve;
process the obtained voltage-frequency relationship curve to determine whether a voltage exceeding a predetermined voltage value is within a predetermined frequency range; and
determine that the pressing signal received by the switch sensor is caused by the user manipulation in response to determining that the voltage exceeding the predetermined voltage value is not within the predetermined frequency range.

3. The system of claim 1, wherein the controller is configured to determine that the pressing signal received by the switch sensor is caused by the user manipulation in response to processing the pressing signal received by the switch sensor and determining that two or more areas on the charging door which are distanced from each other by a predetermined distance are pressed at the same time.

4. The system of claim 3, wherein the predetermined distance is about 3 cm or more.

5. The system of claim 1, wherein the switch sensor includes
a fingerprint recognition module, and
wherein the controller is configured to process the pressing signal received by the switch sensor to determine whether a fingerprint identified in the received pressing signal coincides with a pre-registered fingerprint, and determine that the pressing signal received by the switch sensor is caused by the user manipulator when the fingerprint identified in the received pressing signal coincides with the pre-registered fingerprint.

6. The system of claim 1, wherein, in response to determining that the door lock of the vehicle is in the locked state, the controller is configured to maintain the charging door switch of the vehicle in a closed state.

7. The system of claim 1, wherein the controller is configured to maintain the charging door switch of the vehicle in a closed state in response to determining that the charging door switch of the vehicle is not continuously pressed for more than the predetermined time.

8. The system of claim 2, wherein, in response to determining that the voltage exceeding the predetermined voltage value is within the predetermined frequency range, the controller is configured to maintain the charging door switch of the vehicle in a closed state.

9. The system of claim 1, wherein the predetermined time is about 0.05 sec to 0.2 sec.

10. The system of claim 2, wherein the predetermined frequency range is about 10 Hz or more.

11. A method for controlling opening and closing of a charging door of a vehicle, comprising:
receiving, by a switch sensor, a pressing signal when a charging door switch of the vehicle is pressed;
determining, by a controller, whether a door lock of the vehicle is in a locked state;
processing, by the controller, the pressing signal received by the switch sensor to determine whether the pressing signal received by the switch sensor is caused by a user manipulation in response to determining that the door lock of the vehicle is in an unlocked state and the charging door switch of the vehicle is continuously pressed for more than a predetermined time;
operating, by the controller, the charging door switch of the vehicle to open the charging door in response to determining that the pressing signal received by the switch sensor is caused by the user manipulation.

12. The method of claim 11, further comprising:
processing, by the controller, the pressing signal received by the switch sensor to obtain a voltage-time relationship curve;
performing, by the controller, a fast Fourier transform on the obtained voltage-time relationship curve to obtain a voltage-frequency relationship curve;
processing, by the controller, the obtained voltage-frequency relationship curve to determine whether a voltage exceeding a predetermined voltage value is within a predetermined frequency range; and
determining that the pressing signal received by the switch sensor is caused by the user manipulation in response to determining that the voltage exceeding the predetermined voltage value is not within the predetermined frequency range.

13. The method of claim 11, further comprising: determining, by the controller, that the pressing signal received by the switch sensor is caused by the user manipulation in response to processor the pressing signal received by the switch sensor and determining that two or more areas which are distanced from each other by a predetermined distance are pressed at the same time.

14. The method of claim 13, wherein the predetermined distance is about 3 cm or more.

15. The method of claim 11, wherein the switch sensor includes:
a fingerprint recognition module, and
wherein the controller is configured to process the pressing signal received by the switch sensor to determine whether a fingerprint identified in the received pressing signal coincides with a pre-registered fingerprint, and determine that the pressing signal received by the switch sensor is caused by the user manipulation when the fingerprint identified in the received pressing signal coincides with the pre-registered fingerprint.

16. The method of claim 11, further comprising maintaining, by the controller, the charging door switch of the vehicle in a closed state in response to determining that the door lock of the vehicle is in the locked state.

17. The method of claim 11, further comprising maintaining the charging door switch of the vehicle in a closed state in response to determining that the charging door switch of the vehicle is not continuously pressed for more than the predetermined time.

18. The method of claim 12, wherein the charging door switch of the vehicle is maintained in a closed state by the controller in response to determining that the voltage exceeding the predetermined voltage value is within the predetermined frequency range.

19. The method of claim 11, wherein the predetermined time is about 0.05 sec to 0.2 sec.

20. The method of claim 12, wherein the predetermined frequency range is about 10 Hz or more.
